(19) United States
(12) Patent Application Publication
(10) Pub. No.: US 2008/0151211 A1
(43) Pub. Date: Jun. 26, 2008

(54) MULTIPLE-USE PROJECTION SYSTEM

(75) Inventors: Winfried Kaiser, Aalen (DE); Wilhelm Ulrich, Aalen (DE); Heiko Feldmann, Aalen (DE); Aurelian Dodoc, Heidenheim (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 11/951,746

(22) Filed: Dec. 6, 2007

Related U.S. Application Data
(63) Continuation of application No. PCT/EP2006/005168, filed on May 31, 2006.
(60) Provisional application No. 60/689,259, filed on Jun. 10, 2005.

(51) Int. Cl. G03B 27/72

(52) U.S. Cl. 355/71; 355/77

(57) ABSTRACT

Projection exposure methods and systems for exposing substrates are disclosed. The methods and systems feature projection objectives capable of multiple exposure configurations having different image side numerical apertures and different image field sizes.

### CROSS-REFERENCE TO RELATED APPLICATIONS

This application is a continuation application of and claims priority to International Patent Application No. PCT/EP2006/005168, filed on May 31, 2006, which claims benefit of Provisional Patent Application No. 60/689,259, filed on Jun. 10, 2005. The entire contents of both International Patent Application No. PCT/EP2006/005168 and Provisional Patent Application No. 60/689,259 are incorporated herein by reference.

### BACKGROUND

1. Field of the Disclosure

The disclosure relates to a projection exposure method for exposing substrates, arranged in the region of an image plane of a projection objective, with at least one image of a pattern, arranged in the region of an object plane of the projection objective, of a mask and to a projection objective that can be used in the case of such a projection exposure method, and to a method for producing a projection objective that can be used in the case of such a projection exposure method.

2. Description of the Related Prior Art

Microlithographic projection exposure methods and projection exposure machines are used to produce finely structured semiconductor components and other finely structured subassemblies, for example to produce subassemblies for liquid crystal displays (LCD) or micromechanical elements. Projection exposure machines serve the purpose of projecting patterns of photomasks or reticles, which are denoted below in general as mask or reticle, onto a substrate coated with a radiation-sensitive layer, for example onto a semiconductor wafer coated with photoresist, doing so with high resolution and on a reducing scale.

A microlithography projection exposure machine comprises an illumination system for illuminating the mask with illumination radiation, and a projection objective following the mask, with the aid of which the pattern of the mask is imaged into the image plane of the projection objective. In this case, the radiation varied by the mask penetrates the projection objective, which produces an exposure radiation directed onto the substrate. The radiation strikes the substrate with an angular bandwidth, that can be influenced by the image-side numerical aperture NA of the projection objective, in the region of the image field of the projection objective. The scanner systems currently customary produce nonsquare, rectangular image fields or arcuate image fields (annular fields).

Inside the effectively used image field, the projection objective must have a correction state of its aberrations that suffices for microlithographic imaging, in order to enable imaging of the reticle pattern on the flat substrate surface that is sufficiently free from aberrations in the entire region of the image field. Outside the image field, whose image field size (shape and dimensions) is pre-scribed to the optics designer before the development of a new design, the correction state generally worsens drastically such that no exposure radiation that can be used in practice for imaging exists outside the image field. In order to ensure a sharp transition between a useful image field region and the regions lying outside the image field that cannot be used, it is customary to provide in the projection exposure machine a field stop that determines the image field size and shape and is frequently arranged in the region of a field plane of the illumination system that is upstream of the object plane of the projection objective and optically conjugate to the object plane.

It is generally required when producing LSI semiconductor components that, in order to achieve very fine structures of the order of magnitude of 100 nm or less, at least some layers of a three-dimensionally structured semiconductor component be produced with the aid of projection objectives whose image-side numerical aperture NA suffices, in conjunction with the selected operating wavelength λ from the ultraviolet region, to achieve the desired resolution R=k₁ (λ/NA) (k₁ being an empirical, process-dependent constant). Since it becomes ever more difficult with increasing numerical aperture to correct the image quality for large image fields, very high aperture projection objectives generally have smaller image fields than objectives with a lower numerical aperture.

However, the achievable resolution is only one of numerous criteria that are to be considered when designing a projection exposure method. For economic reasons, there is a desire to maximize the number of substrates exposed per time unit, that is to say the throughput of a projection exposure method. To this end, efforts are made, inter alia, to implement the largest possible exposed area for each exposure process such that there is a general desire to use projection objectives having the largest possible effective image field. As a rule, however, the rise in image field size must be acquired at the expense of a diminution in the maximum achievable resolution.

Consequently, when producing finely structured subassemblies with regions whose structural sizes differ in fineness, use is frequently made of two or more projection exposure machines, projection exposure machines with a relatively large image field and relatively low numerical aperture being used to produce relatively coarse structures, and other projection exposure machines with a relatively high resolution but relatively small image fields being used to produce very fine structures.

### SUMMARY

The disclosure provides a projection exposure method and a projection exposure machine suitable for carrying out the method and a projection objective that can be used in this case, all of which enable economic fabrication of finely structured subassemblies of different structural sizes.

The disclosure provides a projection exposure method that serves for exposing substrates, arranged in the region of an image plane of a projection objective, with at least one image of a pattern, arranged in the region of an object plane of the projection objective, of a mask and comprises the following steps:

illuminating the pattern with illumination radiation of an illumination system;
transirradiating the projection objective to produce exposure radiation that strikes a substrate with an angular bandwidth, that can be influenced by an image-side numerical aperture NA of the projection objective, in the region of an image field of the projection objective;
setting a first exposure configuration for exposing a substrate given a first image-side numerical aperture NA1 in a first image field with a first image field size IFS1;
exposing at least one substrate with the first exposure configuration; coordinatedly oppositely varying image field size and image-side numerical aperture in order to set a second exposure configuration for exposing substrates given a second image-side numerical aperture NA2, differing from the first image-side numerical aperture NA1, in a second image field with a second image field size IFS2 differing from the first image field size; and
exposing at least one substrate with the second exposure configuration.

In this method, the projection exposure machine is operated in two (or more) different exposure configurations. Each exposure configuration represents a specific operating state or operating mode of the projection exposure machine. In this case, both the used image field size and the used image-side numerical aperture NA are varied when going over from one exposure configuration to the other exposure configuration. As a result, a single projection exposure machine can be used to conduct exposure processes with different process parameters both with regard to image field size and with regard to numerical aperture (or resolution). A multiple-use projection system is thereby provided, since both the image field size and the useful image-side numerical aperture can be varied.

The changeover between the first exposure configuration and the second exposure configuration can take place at the place of use of the projection exposure machine, for example in a fabrication facility for microlithographic production of finely structured semiconductor components or other finely structured subassemblies such as liquid crystal displays or micromechanical elements. The projection exposure machine can be designed as a scanner system. In scanner systems, it is customary to use image fields with relatively large aspect ratios between width (perpendicular to the scanning direction) and height (in the scanning direction), for example with an aspect ratio AR between the image field width and image field height of more than 2 or more than 3 or more than 4. Relatively large regions of the substrates to be exposed can effectively be exposed with high apertures and thus with high resolution by a scanner operation. In one variant of the method, the following steps are carried out to this end:
scanning a first substrate with the first exposure configuration;
switching over the projection exposure machine between the first and the second exposure configuration; and
scanning a second substrate with the second exposure configuration.

It is theoretically possible here that one and the same substrate is exposed with the aid of the same projection exposure machine, this being done in temporal sequence with the two exposure configurations. It is provided, as a rule, to configure a first projection exposure machine for the first exposure configuration, and a second projection exposure machine, which can be of substantially identical design, for the second exposure configuration, and to transport a substrate between the first exposure operation and the second exposure operation from the first to the second projection exposure machine.

Switching over a projection exposure machine between the first exposure configuration and the second exposure configuration can be carried out in some cases without carrying out manipulations on their optical elements. In the case of other embodiments, at least one manipulation is provided in conjunction with switching over, in particular a change in spacing of optical elements that can be achieved by relative axial displacement of optical elements, a decentering of one or more optical elements relative to the optical axis, and/or a tilting of optical elements about tilting axes running transverse to the optical axis. Some embodiments of projection objectives have an appropriate manipulator device to this end. Fine tuning of the projection objective at the place of use can be performed for each exposure configuration using at least one such manipulation.

In one embodiment, the first exposure configuration is a resolution-optimized configuration in the case of which the first numerical aperture NA1 is larger than the second numerical aperture NA2 and the first image field size IFS1 is smaller than the second image field size IFS2, and the second exposure configuration is a throughput-optimized configuration in the case of which the second numerical aperture NA2 is smaller than the first numerical aperture NA1 and the second image field size IFS2 is larger than the first image field size IFS1. In the case of the resolution-optimized configuration, the projection exposure machine is adjusted such that, on the one hand, the first numerical aperture NA1 permits the resolution aimed at for the process, and that, on the other hand, the first image field size IFS1 is still sufficiently large to enable a satisfactory throughput of exposed substrates. The throughput-optimized configuration concentrates on a relatively large image field size in order to enable a high throughput. In this case, the numerical aperture NA2 is reduced, but only so far as to yield a sufficient resolution for the structures to be produced. Projection exposure machines according to the disclosure can be used flexibly and therefore have a high customer benefit owing to the possibility of configuring a projection exposure method according to the disclosure or a projection exposure machine suitable therefor such that optimized throughput or optimized resolution can be selected.

In order to achieve the widest possible field of use, the difference ΔNA=|NA1−NA2| can be 0.05 or more, in particular 0.1 or more, such that a large bandwidth of different resolutions is available. The range of different image field sizes can be dimensioned such that the image field area associated with the larger image field size IFS2 is at least 20% or at least 30% or at least 40% or at least 50% larger than the image field area associated with the smaller image field size IFS1.

A projection exposure machine suitable for carrying out the method has:

an illumination system for illuminating the pattern with illumination radiation;
a projection objective for producing an image of the pattern in the region of the image plane of the projection objective with the aid of an exposure radiation directed onto the substrate;
an adjustable aperture stop, arranged in the region of a pupil surface of the projection objective, for variably setting a used image-side numerical aperture of the projection objective;
an adjustable field stop that is arranged in the region of the object plane of the projection objective or in the region of a field plane, optically conjugate to the object plane of the projection objective, of the projection exposure machine; and
a control device for coordinated control of the adjustable field stop and of the adjustable aperture stop,
the control device being configured in such a way that the projection exposure machine can optionally be operated in a first exposure configuration or in at least one second exposure configuration, and
in the first exposure configuration a first image-side numerical aperture NA1 being present in a first image field with a first image field size IFS1, and in the second exposure configuration a second image-side numerical aperture NA2 differing from the first image-side numerical aperture NA1 being present in a second image field with a second image field size IFS2 differing from the first image field size.

The adjustable field stop has the purpose of sharply defining the edges of the image field in order to avoid the occurrence of “gray zones” with insufficiently resolved exposure radiation at the edge of the image field. Consequently, the field stop is to be arranged directly in a field plane or in its immediate vicinity. Since the arrangement in the region of the object plane of the projection objective can be difficult, because the pattern-bearing reticle is already located there, an arrangement in a field plane, optically conjugate to the object plane, of the projection exposure machine or in the vicinity thereof is generally favorable. A freely accessible field plane inside the illumination system, upstream of the object plane in the light propagation direction, is particularly suitable here. A field stop inside the projection objective or in the region of the image-side exit end is likewise possible. If the projection objective produces at least one freely accessible real intermediate image and the latter is sufficiently corrected, the field stop can be seated at this intermediate image. The adjustable aperture stop, whose variably settable stop diameter determines the maximum useful numerical aperture of the projection objective, is arranged in the region of a pupil surface of the projection objective. The adjustable field stop and the adjustable aperture stop are adjusted in a coordinated fashion using the control device when a switchover is made from the first exposure configuration to the second exposure configuration, or vice versa. The adjustment can be performed simultaneously or offset in time. In this case, stopping down the field stop (reducing the image field size) is coupled to stopping up the aperture stop in order to increase the numerical aperture, while stopping up the field stop is linked to stopping down the aperture stop.

Projection objectives that can be used to carry out the method must respectively have a correction state sufficient for microlithographic imaging in the entire image field, both in the first exposure configuration and in the second exposure configuration. This is possible, for example, by virtue of the fact that the optical elements of the projection objective are designed with reference to type and structure such that the maximum desired image-side numerical aperture can be achieved in the case of the maximum desired image field size. In this case, the desired combinations of image field size and image-side numerical aperture are respectively set in the different exposure configurations using the adjustable field stop and the adjustable aperture stop. However, this solution has the disadvantage that such a projection objective can be implemented only with a very high technical outlay, and that during the actually desired operation of the projection objective a portion of its potential (with regard to image field size and/or with regard to achievable numerical aperture) is respectively not utilized.

Projection objectives can be specifically designed and calculated for use in projection exposure machines according to the disclosure, it thereby being possible to implement the desired functionality even with a substantially lesser technical outlay. This can be achieved by virtue of the fact that the optical elements of the projection objective are designed such that the projection objective supplies a sufficient correction state in the respective image field essentially only in the first exposure configuration and in the at least one second exposure configuration differing from the first exposure configuration. To be precise, carrying out the method does not necessitate providing the largest possible numerical aperture in the largest possible image field. Rather, what is important is specific combinations of numerical aperture and image field size in the different exposure configurations, in particular a relatively large image field being combined with a relatively low numerical aperture in one exposure configuration (throughput-optimized), and a relatively large numerical aperture being combined with a substantially smaller image field in another exposure configuration (resolution-optimized). There is thus no need for the projection objective also to have a correction state sufficient for microlithographic imaging in other, unnecessary combinations of numerical aperture and image field size.

Consequently, the disclosure also comprises a method for producing a projection objective with a plurality of optical elements, having the following steps:

carrying out an optical design process for determining the type and arrangement of the optical elements with the aid of a plurality of parameters, the parameters comprising at least one fixed parameter and at least one free parameter, and an optimization of values being carried out for the at least one free parameter on the basis of a merit function, the merit function being selected such that in a first exposure configuration and in at least one second exposure configuration the projection objective has a correction state sufficient for microlithographic imaging in the image field, and
in the first exposure configuration a first image-side numerical aperture NA1 being present in a first image field with a first image field size IFS1, and in the second exposure configuration a second image-side numerical aperture NA2 differing from the first image-side numerical aperture NA1 being present in a second image field with a second image field size IFS2 differing from the first image field size.

This specific type of optimization can be implemented with conventional software for optical design (for example software with the trademark “CODE V®”), in order to provide projection objectives that can be produced with an acceptable technical outlay and which are optimized only for specific combinations of exposure parameters, it being possible for other parameter combinations that are unnecessary in practice to be left out of account. In particular, it is possible thereby to provide projection objectives that in one exposure configuration enable a high substrate throughput in conjunction with an adequate resolution, and in another exposure configuration enable a throughput that, although not quite so high, is still sufficient, in conjunction with a substantially higher resolution.

In some embodiments, projection objectives are designed for use in scanner operation, and therefore designed as a slit-shaped image field with a relatively high aspect ratio AR between the image field width (transverse to the scanning direction) and image field height (in the scanning direction). The aspect ratio AR can, for example, be more than two, more than two and a half, more than three or more than four in the case of at least one exposure configuration. The image field can, for example, be rectangular or arcuate. The projection objective can be adapted to a slit-shaped image field suitable for a scanning operation such that a scanning operation is possible in both the first exposure configuration and the second exposure configuration.

In some embodiments, the projection objective is designed as an immersion objective which is used to image a pattern arranged in the object plane of the projection objective into the image plane of the projection objective with the aid of an immersion medium that can be arranged in the image-side end region of the projection system. For example, the projection objective can be adapted to imaging with the aid of an immersion liquid of high refractive index that is arranged during operation between an image-side last optical surface of the projection objective and the image plane or the input surface of the substrate to be exposed arranged there. A projection objective for near field lithography can also be involved, in which case it is typical to set an image-side working distance of the order of magnitude of the exposure wavelength or therebelow. The image-side last optical element can be a “solid immersion lens (SIL)” that can, if appropriate, be brought into contact with the substrate to be exposed. The advantages of shortening the effectively used operating wavelength and an enlarged depth of focus can be used with immersion systems. In addition, image-side numerical apertures NA≧1 are possible. It holds for some embodiments that: NA1≧1 and NA2≧1.

These and further features of the disclosure emerge from the claims and likewise from the description and the drawings, it being possible for the individual features to be implemented respectively on their own or severally in the form of subcombinations in the case of one embodiment of the disclosure and in other fields, and to constitute designs that are advantageous and protectable per se and for which protection is being claimed here.

### BRIEF DESCRIPTION OF THE DRAWINGS

FIG. 1 shows a schematic of an exemplary embodiment of a microlithography projection exposure machine according to the disclosure in the case of which in the illumination system an adjustable field stop, and in the projection objective an adjustable aperture stop are provided, and the stops can be adjustably coupled via a common control device;

FIG. 2 shows a lens section through an embodiment of a refractive microlithography projection objective in two exposure configurations, (a) showing a first exposure configuration of large numerical aperture and small image field, and (b) showing a second exposure configuration of smaller numerical aperture and larger image field;

FIG. 3 shows a lens section through an embodiment of a microlithography catadioptric projection objective in two exposure configurations, (a) showing a first exposure configuration of large numerical aperture and small image field, and (b) showing a second exposure configuration of smaller numerical aperture and larger image field;

FIG. 4 shows a lens section through an embodiment of another microlithography catadioptric projection objective in two exposure configurations, (a) showing a first exposure configuration of large numerical aperture and small image field and (b) showing a second exposure configuration of smaller numerical aperture and larger image field.

### DETAILED DESCRIPTION

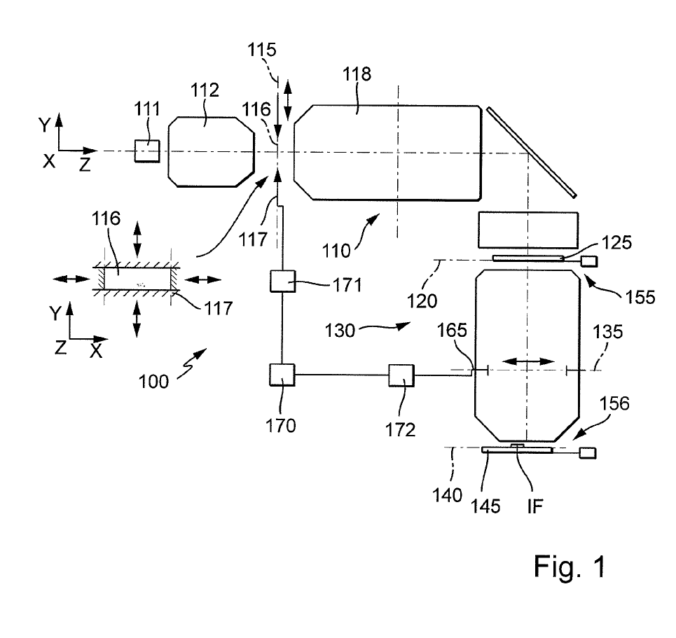

FIG. 1 shows an embodiment of a projection exposure machine 100 for the microlithographic production of integrated circuits and other finely structured components in the case of resolutions as far as fractions of 1 μm. The projection exposure machine comprises an illumination system 110 for illuminating a photomask (reticle) 125 arranged in the exit or image plane 120 of the illumination system, and also a projection objective 130 that images the pattern, arranged in its object plane 120, of the photomask 125 into the image plane 140 of the projection objective on a reducing scale. By way of example, the surface of a semiconductor wafer 145 coated with a photosensitive layer is located in the image plane 140. An excimer laser with an operating wavelength of 248 nm that can be used in the deep ultraviolet (DUV) region serves as light source 111 of the illumination system 110, it also being possible, for example, to use laser with a wavelength of 193 nm or 157 nm in the case of other embodiments. A downstream group 112 of optical devices serves the purpose of reshaping the light from the primary light source 111 and homogenizing it in such a way that there is a rectangular illumination field 116 with a largely homogeneous intensity distribution of the illumination light in an intermediate field plane 115 of the illumination system. The group 112 of optical devices comprises a beam expander, downstream of the laser, that serves to reduce coherence and to shape beams to a rectangular beam cross section. Placed downstream of the beam shaper are optical devices that permit the illumination system to be switched over between various illumination modes, for example between conventional illumination with a variable degree of coherence, annular field illumination and dipole or quadrupole illumination. Moreover, apparatus are provided for homogenizing the illumination intensity distribution in the illumination field that, depending on embodiment, can comprise, for example, light mixing elements such as honeycomb condensers and/or rod-shaped light integrators and/or stop elements and/or other field-defining elements with a light mixing function. Arranged in the intermediate field plane 115 is an adjustable field stop 117 that is also denoted as a reticle masking system (REMA). The rectangular stop aperture of the reticle masking system 117 is precisely adapted to the required field shape of the illumination field on the reticle. In the example, the width in the x-direction is a multiple of the height in the y-direction (compare detail view in FIG. 1). The downstream imaging objective 118, which is also denoted as REMA objective, has a number of lens groups and a deflecting mirror and serves the purpose of imaging the intermediate field plane 115 of the reticle masking system onto the reticle 125.

In a wafer stepper, the entire structured surface, in general a rectangle with any desired aspect ratio between height and width of, for example, 1:1 to 1:2, corresponding to a chip is illuminated on the reticle 125 as uniformly and with as much edge definition as possible. In the case of a wafer scanner of the type illustrated, a narrow strip, for example a rectangle with an aspect ratio AR between image field width (perpendicular to the scanning direction) and image field height (in the scanning direction) of typically 2:1 to 8:1, is illuminated on the reticle 125, and the entire structured field of a chip is serially illuminated by scanning in a direction (scanning direction) corresponding to the y-direction of the illumination system.

A device 155 for holding and manipulating the mask 125 is arranged between illumination system and projection objective in such a way that the pattern arranged on the rear side of the mask facing the projection objective lies in the object plane 120, and can be moved in this plane in order to operate the scanner in the scanning direction (y-direction) using a scanning drive.

Following downstream of the mask in the light propagation direction is the projection objective 130, which acts as a reduction objective and images an image of a pattern arranged on the mask at a reduced scale, for example at the scale 1:4 or 1:5, onto the wafer 145, which is coated with a photoresist and whose coated surface is arranged in the image plane 104 of the projection objective. Other reduction scales, for example a stronger reduction as far as 1:20 or 1:200, are possible. The wafer 145 is held by a device 156 that comprises a scanner drive for the purpose of moving the wafer synchronously with the mask 125 and parallel thereto.

A pupil surface 135 of the projection objective lies between the object plane 120 and the image plane 140 of the projection objective 130. Arranged in the region of this pupil surface is an adjustable aperture stop 165 with the aid of which the desired image-side numerical aperture NA of the projection objective can be set.

The intermediate field plane 115, in which the adjustable field stop 117 is seated, is optically conjugate to the object plane 120 of the projection objective in which the pattern to be imaged is located. Consequently, the shape and the size of the exposed region on the photomask is determined from the shape and size of the stop aperture of the field stop. The object plane 120 of the projection objective is optically conjugate to the image plane 140 thereof in which the substrate (wafer 145) to be exposed is located. Consequently, the adjustable field stop can be used to set the image field size of the effective image field IF of the projection exposure machine on the substrate 145 with reference to shape and size. In the case of the example, both the height in the y-direction (scanning direction) and the width in the x-direction can be adjusted independently of one another. This purpose is served by control signals that are produced by a control device 170 of the projection exposure machine and are transmitted to an adjusting drive 171 of the field stop 117.

The adjustable aperture stop 165 is likewise driven by the control device 170, which outputs appropriate control signals to an adjusting drive 172 for the aperture stop 165. The aperture stop 165 is used to set the numerical aperture that is respectively used during exposure and which determines and delimits the angular bandwidth of the radiation impinging on the substrate in the region of the image field IF.

The control device 170 is configured in this embodiment such that two operating states or exposure configurations of the projection exposure machine are possible. In a first exposure configuration, in which the projection exposure machine is optimized to the largest possible throughput of exposed substrates, the projection exposure machine is operated by stopping up the field stop 117 (enlarging its diameter) and stopping down the aperture stop 165 (diminishing its diameter) with relatively large image field and relatively small resolution (determined by the NA). In this operating state, relatively large exposure regions can be exposed on the substrates with comparatively coarse structures. Since a relatively large image field IF can be illuminated during each exposure operation, the throughput of exposed substrates can be optimized, use being made only of the numerical aperture or resolution required for the corresponding structural sizes. If the aim is to expose relatively fine structures, the machine can be switched over quickly and simply into a resolution-optimized configuration in the case of which it is possible to image with the maximum possible numerical aperture or the system in a relatively small image field IF. To this end, the control device 170 is used to coordinate the field stop 117 and the aperture stop 165 and to drive them oppositely such that by stopping down the field stop (diminishing the diameter in at least one direction) and stopping up the aperture stop 165 (enlarging its diameter) the effective image field size is reduced and, contrary thereto, the numerical aperture and thus the resolution are enlarged. In this resolution-optimized configuration, it is also possible to expose very fine structures using the same projection exposure machine in conjunction with a reduced throughput.

The control device 170 is configured such that only specific combinations of image field size and image-side numerical aperture can be set, specifically for the purpose of a coordinated opposite variation of image field size and image-side numerical aperture when switching over between different exposure configurations. By comparison with conventional projection exposure machines, this stipulation of specific combinations of image field size and numerical aperture results in expanded possibilities of use, since the projection exposure machine can easily be adapted to different projection processes. Consequently, a more flexible and thus more cost-effective fabrication process is possible for components that contain structures of different structural sizes.

In the case of the described configuration of the control device 170, the maximum numerical aperture is coupled to a specific, maximum image field size. The coupling can be effected by an appropriate part of a control program. The control device 170 also permits other control possibilities. For example, it is possible in another configuration to adjust the stop diameter of the round aperture stop 165 independently of an adjustment of the rectangular field stop, in order, for example, to reduce or to enlarge the stop diameter of the aperture stop, and thus the image-side numerical aperture, in conjunction with an unchanged field size. In another configuration, it is possible to increase the diameter of the aperture stop only in conjunction with adjusting the diameter of the field stop.

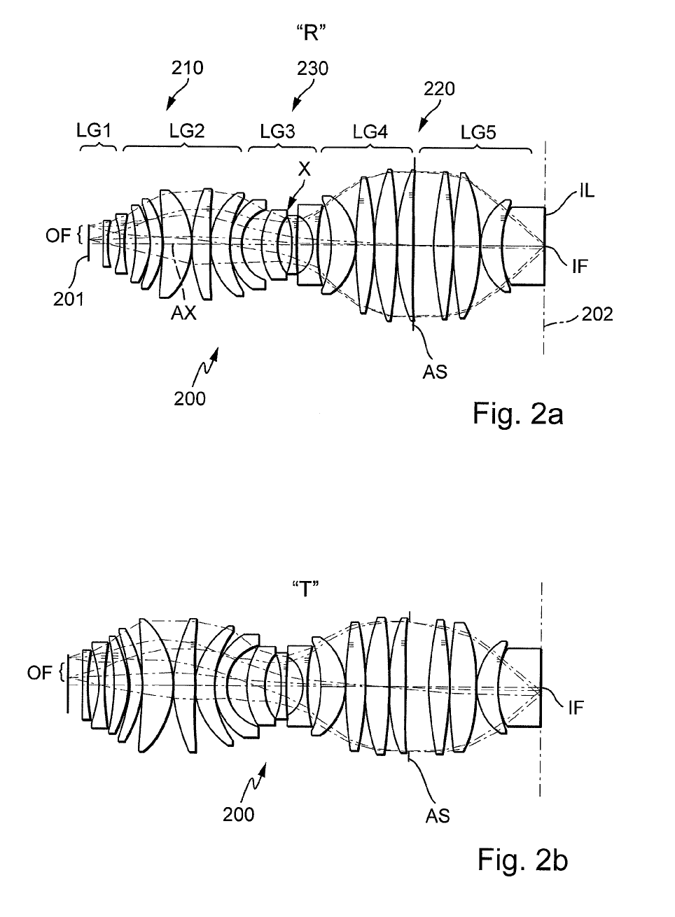

FIGS. 2 to 4 are used to describe various embodiments of projection objectives that are adapted specifically to use in a projection exposure machine that can be operated with at least two different image field sizes and at least two different numerical apertures. In each of FIGS. 2 to 4, the upper part figure (a) shows the beam path inside the projection objective in a resolution-optimized configuration in the case of which the projection objective is operated with a relatively small image field IF and maximum numerical aperture NA, while the lower part figure (b) shows, for the identical projection objective, the beam path in a throughput-optimized configuration in which the image field IF is larger than in the resolution-optimized configuration, while the numerical aperture used is smaller. The resolution-optimized configuration is also denoted as mode “R”, R standing for “resolution”. The throughput-optimized configuration is, again, denoted as mode “T”, T standing for “throughput”. The size of the object field OF and the size of the image field IF, which is coupled to the field size via the reduction ratio of the projection objective, are determined by the setting of the adjustable field stop inside the upstream illumination system (compare FIG. 1). The numerical aperture used is respectively set via the variable diameter of the aperture stop AS of the projection objective.

In the following description of various embodiments of projection objectives, the term “optical axis” respectively denotes a straight line through the centers of curvature of the optical elements. Directions and distances are described as image-side or toward the image when they are directed in the direction of the image plane or the substrate to be exposed, which is located there, and as object-side or toward the object when they are directed toward the object with reference to the optical axis.

When tables are specified for the embodiments shown in the figures, they are denoted by the same numerals as the associated figures.

FIG. 2 shows an example of a purely refractive projection objective 200 that is designed as an immersion objective for the purpose of imaging a pattern, arranged in its object plane 201, of a reticle or the like into its image plane 202 at a reduced scale in conjunction with virtually homogenous immersion (reduction ratio β=0.25). This is a rotationally symmetrical one-waist system or two-belly system with five consecutive lens groups that are arranged along an optical axis AX at right angles to the object plane and image plane. The first lens group LG1, which is directly downstream of the object plane 201, is of negative refractive power. A second lens group LG2 directly downstream thereof is of positive refractive power. A third lens group LG3 directly downstream thereof is of negative refractive power. A fourth lens group LG4 directly downstream thereof is of positive refractive power. A fifth lens group LG5 directly downstream thereof is of positive refractive power. The image plane is directly downstream of the fifth lens group, and so the projection objective has no further lenses or lens groups apart from the first to fifth lens groups. This distribution of refractive power produces a two-belly system that has an object-side first belly 210, an image-side second belly 220 and a waist 230 that lies therebetween and in which there lies a site of constriction X with a minimum beam diameter. The adjustable aperture stop AS lies in the region of maximum beam diameter in a transitional region from the fourth lens group to the fifth lens group.

The projection objective designed for an operating wavelength of 248 nm and scanner operation has an object-side working distance of approximately 8 mm and an image-side working distance of approximately 2 mm that can be filled up during operation by an immersion liquid IL. The system is designed such that deionized water (refractive index n_{H2O}=1.378), or another suitable trans-parent liquid of comparable refractive index, can be used as immersion liquid.

The specification of the design is summarized in tabular form in table 2. Here, column 1 specifies the number of a refractive surface or one distinguished in another way, column 2 specifies the radius r of the surface (in mm), column 3 specifies the distance d, specified as thickness, of the surface from the down-stream surface (in mm), column 4 specifies the material of the optical element, and column 5 specifies the associated refractive index for the operating wavelength. The free radii, or the free half diameters, of the optical elements that are used in the respective mode are specified (in mm) in columns 6 and 7. Here, column 6 specifies the values for the resolution-optimized mode R, and column 7 specifies the values for the throughput-optimized mode T.

Since the actually used diameters or radii differ in the different operating states at each of the optical surfaces, the projection objective must be fabricated such that the maximum value of the diameters or radii occurring at the respective optical surface is available.

In the embodiment, ten of the surfaces are aspheric, specifically the surfaces 2, 5, 6, 13, 21, 23, 26, 31, 35 and 39. Table 2A specifies the corresponding asphere data, the aspheric surfaces being calculated using the following rule:

p(h)=[((1/r)h²)/(1+SQRT(1−(1+K)(1/r)²h²))]+C1*h⁴+C2*h⁶+ . . .

Here, the reciprocal (1/r) of the radius specifies the surface curvature, and h specifies the distance of a surface point from the optical axis (that is to say the beam height). Thus, p(h) gives the so-called sagitta, that is to say the distance of the surface point from the surface apex in the z-direction, that is to say in the direction of the optical axis. The constants K, C1, C2, . . . are reproduced in table 2A.

In the resolution-optimized configuration (mode “R”, FIG. 2(a)), an image field of size 18×8 mm² is achieved in conjunction with an image-side numerical aperture NA=1.05, the correction state being 1.65 mλ inside the image field. In the throughput-optimized configuration (mode “T”, FIG. 2(b)), an image field of size 26×10.5 mm² (image circle diameter 28.04 mm (T) or 19.7 mm (R)) is exposed in conjunction with an image-side numerical aperture NA=0.94, the correction state being 1.6 mλ. This value for the correction state denotes a mean value of optical path deviations for various beams over the exit pupil of the projection objective (monochromatic errors).

The excellent correction state in the two operating states is based, inter alia, on the circumstance that stopping down the field stop or the aperture stop suppresses or reduces precisely those aberrations that interfere particularly strongly with the imaging quality of the projection objective in the respective mode. In the case of the throughput-optimized configuration, higher orders of the obliquely spherical aberration and of the circular coma are effectively removed by reducing the diameter of the aperture stop. In the case of the resolution-optimized configuration, it is primarily higher orders of field curvature and of astigmatism that are reduced or removed by reducing the field size. The elliptical coma is likewise reduced in both configurations by stopping down the respective stop.

It is to be seen that in the case of the resolution-optimized mode “R” there is a need for substantially larger maximum lens diameters in the image-side second belly 220 than in the throughput-optimized configuration. By contrast, in the case of the throughput-optimized configuration “T”, the maximum used lens diameters are larger in the first belly than in the case of the resolution-optimized configuration. During the switch between the operating states, the optically used diameters remain virtually unchanged in the region of the waist.

One advantage of projection objectives according to the disclosure as against conventional projection objectives resides in the fact that a simpler system design is possible in conjunction with comparable optical performance, for example by reducing the number of lenses and/or the number of aspheric surfaces, since there is less need for correction mechanism. It is possible thereby to reduce the overall blank mass required to produce the lenses, and/or to simplify the fabrication. In a refractive two-belly system of the type shown with NA=1.05 and a field size of 26 mm×10.5 mm, a gain in mass of 15% to 20%, for example, is to be expected as against conventional systems of the same NA and field size. The possible savings depend on the variation ranges of the systems that can be set.

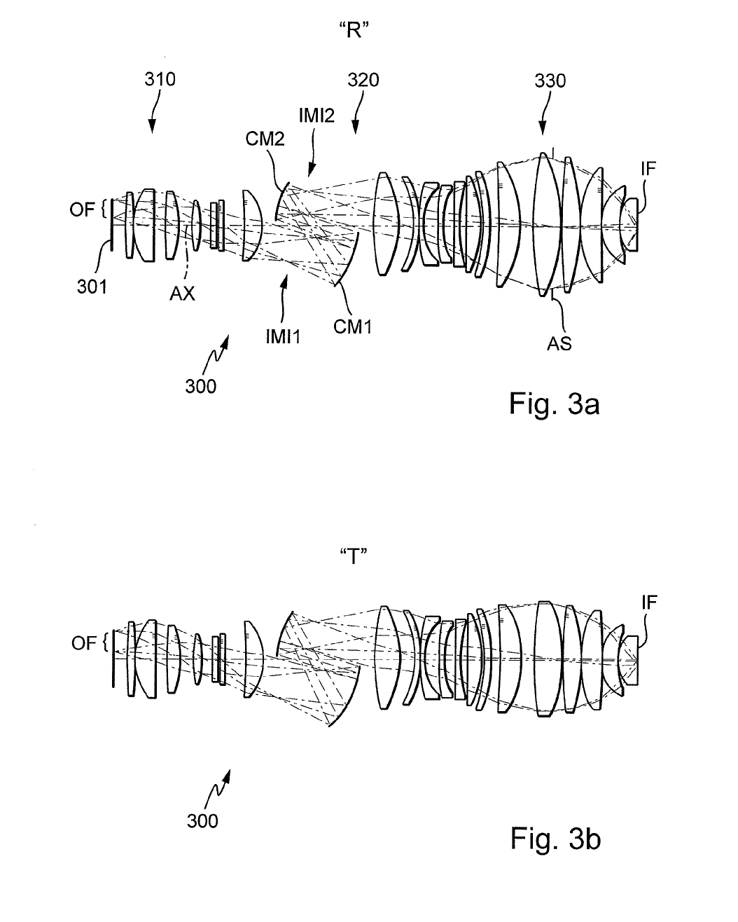

FIG. 3 shows an embodiment of a catadioptric projection objective 300 in the resolution-optimized configuration “R” (a), and in the throughput-optimized configuration “T” (b). The projection objective designed for immersion lithography at 193 nm with water (n=1.436) as immersion liquid is configured such that the object field located in the object plane 301 is imaged into the image field IF lying in the image plane 302 at a reduction ratio (β=0.25) with the production of two real intermediate images IMI1 and IMI2. A first, refractive objective part 310 images the object field OF into the first intermediate image IMI1. A second, catoptric (purely reflective) objective part 320 images the first intermediate image IMI1 into the second intermediate image IMI2. A third, purely refractive objective part 330 images the second intermediate image IMI2 into the image field IF. Inside the third objective part 330 which has a strongly reducing action, the adjustable aperture stop AS is arranged in the region of largest beam diameters between the lens of maximum diameter and the image plane. The second objective part 320 has a first concave mirror CM1 with a concave reflective surface pointing toward the object surface, and a second concave mirror CM2 with a concave reflective surface pointing toward the image surface. The reflective surfaces of the two concave mirrors are continuous or free from interruptions, that is to say they have no holes or bores. The mutually facing reflective surfaces define a mirror interspace that is enclosed by the curved surfaces that are defined by the concave reflective surfaces. The intermediate images IMI1 and IMI2 (at least the paraxial intermediate images) lie substantially inside this mirror interspace.

Each reflecting surface of a concave mirror defines a curved surface that is defined as a mathematical surface that extends beyond the edges of the physical mirror and includes the reflecting surface. The first and second concave mirrors are parts of rotationally symmetrical curved surfaces that have a common axis of rotational symmetry that coincides with the optical axis AX of the projection objective. The lenses of the first and third objective parts are also centered about this axis such that the projection objective has a single, straight, unfolded optical axis AX. The concave mirrors have relatively small diameters and can thereby be arranged relatively close to one another respectively in the optical vicinity of the intermediate images, that is to say in a near-field fashion. The concave mirrors lying on opposite sides of the optical axis outside the optical axis are illuminated in an extra-axial fashion. The beam that is respectively passed by the concave mirrors on their side facing the optical axis is not intersected by the concave mirrors, and so imaging free from vignetting is possible. Since the reflecting surfaces are continuous over the entire illuminated region, the imaging is also free from pupil obscuration.

The projection objective has three pupil surfaces, respectively wherever the principal ray of optical imaging cuts the optical axis. A particular feature of this design type consists in that the two concave mirrors lie at an optical distance from pupil surfaces of the imaging, in which case they lie, in particular, optically closer to the next field plane (intermediate image) than to the next pupil surface. This configuration favors a compact, slim design of the system and a small mirror size. Nevertheless, this configuration permits highest image-side numerical apertures that can lie at values of NA>1 in the case of immersion lithography.

Projection objectives of this design type are disclosed in US provisional applications 60/536,248 (application date Jan. 14, 2004), 60/587,504 (application date Jul. 14, 2004), 60/617,674 (application date Oct. 13, 2004), 60/591,775 (application date Jul. 27, 2004) and 60/612,823 (application date Sep. 24, 2004). The disclosure content of these applications is incorporated into this description by reference.

A particular feature of the projection objective 300 consists in that it is specifically optimized so as to have a correction state sufficient for projection lithography in, on the one hand, a resolution-optimized operating state with a large numerical aperture and relatively small image field and in, on the other hand, a throughput-optimized operating state with a relatively smaller numerical aperture and therefor larger image field, without this correction state also having to be present in the case of the highest possible numerical aperture with the largest possible image field. This results in a simplified design of the projection objective.

The specification of the projection objective is given in tables 3 and 3A (aspheric constants).

In the resolution-optimized configuration (mode “R”, FIG. 3(a)), an image field of size 18×8 mm² (image circle diameter 29.01 mm) is achieved in conjunction with an image-side numerical aperture NA=1.25, the correction state being 3.0 mλ inside the image field. In the throughput-optimized configuration (mode “T”, FIG. 3(b)), an image field of size 26×6 mm² (image circle diameter 33.0 mm) in conjunction with an image-side numerical aperture NA=1.15, the correction state being 2.5 mλ.

By comparison with a conventional projection objective of this type with a numerical aperture NA=1.25 corresponding to the maximum value, and an image field size of 26×6 mm² corresponding to the maximum value, a mass gain of between 5% and 10% is to be expected with this variant.

The projection objective 300 in FIG. 3 is an example of a “concatenated” projection system that has a number of objective parts respectively configured as imaging systems that are linked via intermediate images, the image (intermediate image) produced by an imaging system upstream in the optical path serving as object for the imaging system that is downstream in the optical path and can produce a further intermediate image or is the terminal imaging system of the projection objective that produces the image field IF in the image plane of the projection objective. In this sequence, the projection objective 300 has a refractive objective part that produces the first intermediate image IMI1, a catoptric objective part that produces the second intermediate image IMI2, and a downstream refractive objective part that images the second intermediate image into the image plane. Systems of this type are also denoted as R-C-R systems, R denoting a refractive imaging system, and C denoting a catadioptric or catoptric imaging system.

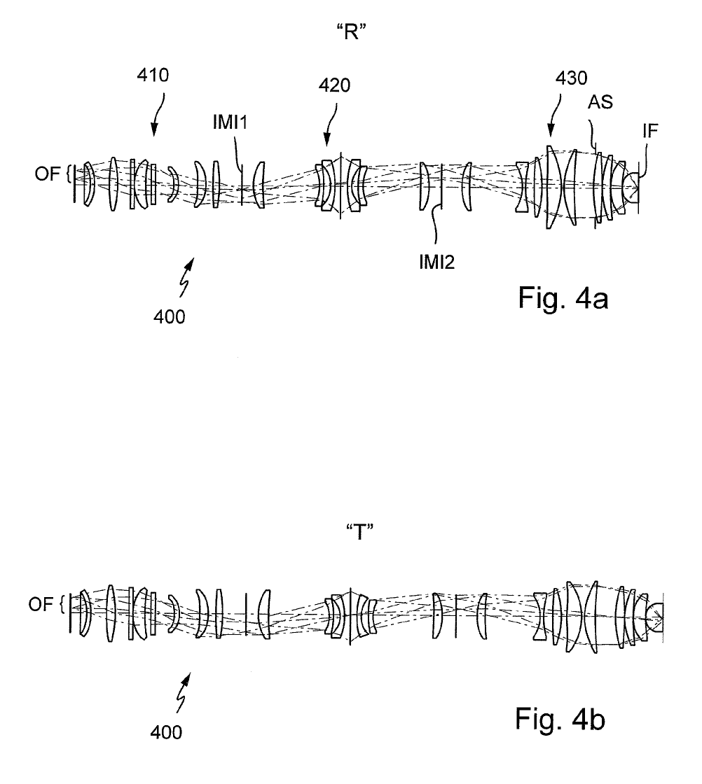

FIG. 4 shows another exemplary embodiment of a catadioptric projection objective of type R-C-R, the catadioptric objective part arranged between the refractive objective parts having a single concave mirror near the pupil and negative meniscus lenses in the immediate vicinity thereof. Catadioptric projection objectives of this type are shown, for example, in patent applications EP 1 191 378 A1, WO 2004/019128 A, WO 03/036361 A1 or US 2003/0197946 A1. Projection objectives of this design are also disclosed in U.S. provisional 60/571,533 of the applicant with application date May 17, 2004. The content of this patent application is incorporated in this description by reference.

The refractive first objective part 410 produces a first intermediate image in IMI1 that is imaged into the second intermediate image IMI2 by the catadioptric second objective part 420. The second intermediate image is imaged into the image field IF by the refractive third objective part 430, which has a reducing effect.

An image field of size 18×8 mm² (image circle diameter 25.8 mm) is achieved in the resolution-optimized configuration (mode “R”, FIG. 4(a)) in conjunction with an image-side numerical aperture NA=1.2, the correction state being 2.80 mλ inside the image field. An image field of size 26×6 mm² (image circle diameter 28.9 mm) is exposed in the throughput-optimized configuration (mode “T”, FIG. 4(b)) in conjunction with an image-side numerical aperture NA=1.1, the correction state being 1.87 mλ.

In the case of this system type, the expected mass gain lies between approximately 10% and 15% when use is made as comparison system of a conventional system with the maximum value of the achievable numerical aperture (NA=1.2) and the maximum value of the settable image field size (26×5 mm²).

TABLE 2

| | | | | Refractive index | Diameter | Diameter |
|---|---|---|---|---|---|---|
| Surface | Radii | Thicknesses | Material | 248.413 nm | Mode R | Mode T |
| 1 | 0.000000 | −0.072693 | AIR | 1.00000000 | 46.964 | 63.948 |
| 2 | −1302.667511 | 7.998741 | SIO2V248 | 1.50885281 | 46.889 | 63.914 |
| 3 | 196.692177 | 28.129122 | N2VP950 | 1.00027962 | 49.235 | 67.308 |
| 4 | −202.480579 | 8.098000 | SIO2V248 | 1.50885281 | 55.209 | 69.447 |
| 5 | 249.985895 | 25.488685 | N2VP950 | 1.00027962 | 63.720 | 84.257 |
| 6 | −398.153752 | 30.842620 | SIO2V248 | 1.50885281 | 73.325 | 89.749 |
| 7 | −172.338789 | 0.988872 | N2VP950 | 1.00027962 | 82.864 | 97.363 |
| 8 | −281.572232 | 26.034037 | SIO2V248 | 1.50885281 | 87.656 | 105.021 |
| 9 | −187.504256 | 1.115266 | N2VP950 | 1.00027962 | 94.695 | 110.966 |
| 10 | −1216.746208 | 64.914157 | SIO2V248 | 1.50885281 | 104.599 | 127.290 |
| 11 | −169.831664 | 0.982779 | N2VP950 | 1.00027962 | 112.900 | 130.956 |
| 12 | 301.688224 | 38.955319 | SIO2V248 | 1.50885281 | 116.898 | 133.008 |
| 13 | 2044.175013 | 0.985377 | N2VP950 | 1.00027962 | 115.167 | 131.546 |
| 14 | 128.666516 | 41.386546 | SIO2V248 | 1.50885281 | 106.848 | 115.789 |
| 15 | 166.254414 | 1.000700 | N2VP950 | 1.00027962 | 98.436 | 109.413 |
| 16 | 114.443649 | 25.290468 | SIO2V248 | 1.50885281 | 92.252 | 99.630 |
| 17 | 81.907318 | 47.642829 | N2VP950 | 1.00027962 | 74.679 | 78.405 |
| 18 | 153.499132 | 33.154632 | SIO2V248 | 1.50885281 | 71.231 | 75.505 |
| 19 | 101.879747 | 35.573923 | N2VP950 | 1.00027962 | 60.367 | 62.004 |
| 20 | −186.096456 | 8.039317 | SIO2V248 | 1.50885281 | 59.698 | 61.035 |
| 21 | 416.793292 | 37.189745 | N2VP950 | 1.00027962 | 60.621 | 60.459 |
| 22 | −79.809917 | 7.995224 | SIO2V248 | 1.50885281 | 61.173 | 60.629 |
| 23 | 249.938762 | 31.064230 | N2VP950 | 1.00027962 | 81.766 | 77.441 |
| 24 | −269.092666 | 54.252305 | SIO2V248 | 1.50885281 | 88.265 | 84.301 |
| 25 | −126.328112 | 0.997600 | N2VP950 | 1.00027962 | 102.020 | 98.081 |
| 26 | 736.255875 | 40.359699 | SIO2V248 | 1.50885281 | 139.559 | 122.803 |
| 27 | −548.458962 | 0.991743 | N2VP950 | 1.00027962 | 142.407 | 126.407 |
| 28 | 469.537353 | 47.985793 | SIO2V248 | 1.50885281 | 156.031 | 133.763 |
| 29 | −1089.760161 | 0.994232 | N2VP950 | 1.00027962 | 156.620 | 134.398 |
| 30 | 428.445040 | 36.166926 | SIO2V248 | 1.50885281 | 157.268 | 133.912 |
| 31 | −2143.451527 | 6.703445 | N2VP950 | 1.00027962 | 156.061 | 132.049 |
| 32 | 0.000000 | 0.000000 | N2VP950 | 1.00027962 | 155.767 | 131.232 |
| 33 | 0.000000 | 39.337335 | N2VP950 | 1.00027962 | 155.767 | 131.232 |
| 34 | 600.430560 | 41.974581 | SIO2V248 | 1.50885281 | 154.506 | 131.374 |
| 35 | −480.437226 | 1.039819 | N2VP950 | 1.00027962 | 153.477 | 130.188 |
| 36 | 622.726362 | 58.957183 | SIO2V248 | 1.50885281 | 149.161 | 126.505 |
| 37 | −367.798301 | 0.992546 | N2VP950 | 1.00027962 | 147.409 | 122.343 |
| 38 | 107.899902 | 46.156199 | SIO2V248 | 1.50885281 | 92.728 | 87.727 |
| 39 | 195.694821 | 2.312954 | N2VP950 | 1.00027962 | 83.691 | 76.499 |
| 40 | 175.751239 | 86.062335 | SIO2V248 | 1.50885281 | 78.118 | 72.339 |
| 41 | 0.000000 | 2.000000 | H2OV248 | 1.37831995 | 12.211 | 15.897 |
| 42 | 0.000000 | 0.000000 | AIR | 0.00000000 | 9.848 | 14.020 |

TABLE 2A
Aspheric constants

| | SRF | | | | |
|---|---|---|---|---|---|
| | 2 | 5 | 6 | 13 | 21 |
| K | 0 | 0 | 0 | 0 | 0 |
| C1 | 1.762802e−07 | −5.693951e−08 | −2.730513e−08 | −1.157766e−08 | 3.393632e−08 |
| C2 | −2.376446e−11 | −6.962441e−12 | 2.772220e−12 | 1.991865e−13 | −2.277531e−12 |
| C3 | 1.297745e−15 | 1.070452e−15 | 5.922007e−17 | 1.085203e−18 | −4.236008e−16 |
| C4 | −1.718740e−19 | −1.127738e−19 | 5.495961e−21 | −3.373108e−23 | −3.797930e−20 |
| C5 | 4.054056e−24 | 6.765257e−24 | 3.071371e−25 | 4.157187e−29 | −4.014952e−24 |
| C6 | 1.897678e−28 | −1.833667e−28 | −5.126985e−29 | 4.276888e−32 | −1.739834e−27 |
| C7 | 0.000000e+00 | 0.000000e+00 | 0.000000e+00 | 0.000000e+00 | 0.000000e+00 |
| C8 | 0.000000e+00 | 0.000000e+00 | 0.000000e+00 | 0.000000e+00 | 0.000000e+00 |
| C9 | 0.000000e+00 | 0.000000e+00 | 0.000000e+00 | 0.000000e+00 | 0.000000e+00 |
| | SRF | | | | |
| | 23 | 26 | 31 | 35 | 39 |
| K | 0 | 0 | 0 | 0 | 0 |
| C1 | −9.417334e−08 | −8.849115e−09 | 1.781722e−08 | 2.077534e−08 | −6.149569e−08 |
| C2 | 4.498897e−12 | 2.735025e−13 | −1.037871e−13 | 1.503483e−13 | 1.756504e−12 |
| C3 | −2.730222e−16 | −2.754782e−18 | −4.359959e−19 | 3.236867e−19 | 1.746839e−16 |
| C4 | 2.264509e−20 | 8.985920e−24 | 2.947494e−24 | 2.336781e−23 | −2.259427e−20 |
| C5 | −1.381091e−24 | −3.282858e−28 | 4.366383e−27 | −3.449099e−27 | 1.474639e−24 |
| C6 | 3.399088e−29 | −6.661244e−32 | −8.597105e−32 | 5.902382e−32 | −4.491123e−29 |
| C7 | 0.000000e+00 | 0.000000e+00 | 0.000000e+00 | 0.000000e+00 | 0.000000e+00 |
| C8 | 0.000000e+00 | 0.000000e+00 | 0.000000e+00 | 0.000000e+00 | 0.000000e+00 |
| C9 | 0.000000e+00 | 0.000000e+00 | 0.000000e+00 | 0.000000e+00 | 0.000000e+00 |

TABLE 3

| | | | | Refractive index | | |
|---|---|---|---|---|---|---|
| Surface | Radii | Thicknesses | Material | 193.368 nm | Diameter R | Diameter T |
| 1 | 0.000000 | −0.110273 | LV193975 | 1.00030962 | 67.893 | 75.039 |
| 2 | 552.922839 | 17.739870 | SIO2V | 1.56078570 | 68.734 | 75.862 |
| 3 | −791.980522 | 0.853400 | HEV19397 | 1.00003289 | 71.025 | 77.878 |
| 4 | 135.511890 | 49.687153 | SIO2V | 1.56078570 | 78.339 | 86.046 |
| 5 | −14679.415704 | 26.612039 | HEV19397 | 1.00003289 | 75.622 | 82.930 |
| 6 | 750.294367 | 32.411945 | SIO2V | 1.56078570 | 71.676 | 77.318 |
| 7 | −145.353310 | 32.604775 | HEV19397 | 1.00003289 | 69.910 | 75.364 |
| 8 | 260.488175 | 20.260017 | SIO2V | 1.56078570 | 47.499 | 47.406 |
| 9 | −241.103014 | 28.375029 | HEV19397 | 1.00003289 | 43.412 | 42.641 |
| 10 | 0.000000 | 10.987787 | SIO2V | 1.56078570 | 44.884 | 43.913 |
| 11 | 0.000000 | 5.719642 | HEV19397 | 1.00003289 | 47.731 | 47.321 |
| 12 | 4393.500262 | 11.752079 | SIO2V | 1.56078570 | 50.001 | 50.102 |
| 13 | −1238.426665 | 49.431426 | HEV19397 | 1.00003289 | 53.047 | 53.717 |
| 14 | −751.127900 | 39.135775 | SIO2V | 1.56078570 | 72.658 | 77.386 |
| 15 | −119.672869 | 36.404550 | HEV19397 | 1.00003289 | 77.495 | 81.924 |
| 16 | 0.000000 | 199.890642 | HEV19397 | 1.00003289 | 81.380 | 93.713 |
| 17 | −184.292791 | −199.890642 | REFL | 1.00003289 | 142.044 | 157.914 |
| 18 | 149.083552 | 199.890642 | REFL | 1.00003289 | 94.403 | 102.560 |
| 19 | 0.000000 | 36.415652 | HEV19397 | 1.00003289 | 97.189 | 104.707 |
| 20 | 471.187176 | 59.155227 | SIO2V | 1.56078570 | 106.644 | 114.298 |
| 21 | −236.474893 | 36.856364 | HEV19397 | 1.00003289 | 107.408 | 114.715 |
| 22 | −198.735228 | 10.954727 | SIO2V | 1.56078570 | 98.154 | 103.177 |
| 23 | −228.092784 | 0.885362 | HEV19397 | 1.00003289 | 98.793 | 103.698 |
| 24 | 275.479185 | 9.987042 | SIO2V | 1.56078570 | 88.064 | 89.776 |
| 25 | 111.076403 | 35.193064 | HEV19397 | 1.00003289 | 79.659 | 80.304 |
| 26 | 549.897716 | 9.976722 | SIO2V | 1.56078570 | 80.303 | 80.491 |
| 27 | 143.876050 | 29.674008 | HEV19397 | 1.00003289 | 80.360 | 79.497 |
| 28 | 5200.622745 | 9.986724 | SIO2V | 1.56078570 | 83.320 | 81.954 |
| 29 | 310.731892 | 16.205427 | HEV19397 | 1.00003289 | 90.049 | 86.977 |
| 30 | 1428.739355 | 35.567623 | SIO2V | 1.56078570 | 95.583 | 91.410 |
| 31 | −211.099695 | 5.752875 | HEV19397 | 1.00003289 | 100.651 | 95.996 |
| 32 | −550.188365 | 14.548694 | SIO2V | 1.56078570 | 107.157 | 100.622 |
| 33 | −363.269629 | 22.725761 | HEV19397 | 1.00003289 | 111.883 | 104.399 |
| 34 | −27906.531905 | 48.714752 | SIO2V | 1.56078570 | 130.642 | 117.050 |
| 35 | −247.243434 | 32.104906 | HEV19397 | 1.00003289 | 134.541 | 121.326 |
| 36 | 759.198618 | 62.117460 | SIO2V | 1.56078570 | 151.824 | 126.597 |
| 37 | −340.892858 | −21.693879 | HEV19397 | 1.00003289 | 152.355 | 126.165 |
| 38 | 0.000000 | 0.000000 | HEV19397 | 1.00003289 | 149.227 | 125.483 |
| 39 | 0.000000 | 25.162321 | HEV19397 | 1.00003289 | 149.227 | 125.483 |
| 40 | 585.693847 | 43.897697 | SIO2V | 1.56078570 | 145.368 | 122.408 |
| 41 | −431.692809 | 0.841035 | HEV19397 | 1.00003289 | 144.374 | 120.849 |
| 42 | 200.571570 | 49.538030 | SIO2V | 1.56078570 | 119.397 | 105.784 |
| 43 | 2660.275699 | 0.683686 | HEV19397 | 1.00003289 | 113.695 | 97.468 |
| 44 | 91.146195 | 42.088089 | SIO2V | 1.56078570 | 76.931 | 71.956 |
| 45 | 192.455450 | 0.128578 | HEV19397 | 1.00003289 | 64.911 | 57.843 |
| 46 | 80.442349 | 37.589666 | CAF2V193 | 1.50185255 | 50.298 | 47.388 |
| 47 | 0.000000 | 0.300000 | SIO2V | 1.56078570 | 20.237 | 20.862 |
| 48 | 0.000000 | 0.000000 | SIO2V | 1.56078570 | 19.835 | 20.534 |
| 49 | 0.000000 | 3.000000 | H2OV193B | 1.43662694 | 19.835 | 20.534 |
| 50 | 0.000000 | 0.000000 | AIR | 0.00000000 | 14.507 | 16.500 |

TABLE 3A
Aspheric constants

| | SRF | | | | |
|---|---|---|---|---|---|
| | 2 | 5 | 7 | 12 | 14 |
| K | 0 | 0 | 0 | 0 | 0 |
| C1 | −6.834688e−08 | −3.911005e−08 | 1.853239e−07 | −1.075639e−07 | −4.036041e−08 |
| C2 | −1.451029e−12 | 1.013164e−11 | −1.293244e−11 | 3.030945e−12 | 1.445764e−12 |
| C3 | −1.668577e−16 | 2.730639e−16 | 1.669661e−15 | −1.463342e−15 | −1.102520e−16 |
| C4 | 8.415518e−20 | −4.457234e−20 | −6.862483e−20 | 1.954705e−19 | 1.117945e−20 |
| C5 | −7.470573e−24 | −2.662718e−24 | −6.039722e−25 | −2.948918e−23 | −8.695179e−25 |
| C6 | 3.170726e−28 | 1.713685e−28 | 3.366586e−28 | 3.370311e−27 | 3.333827e−29 |
| | SRF | | | | |
| | 17 | 18 | 23 | 31 | 32 |
| K | −1.87747 | −1.8612 | 0 | 0 | 0 |
| C1 | −2.645913e−08 | 5.633634e−08 | −5.741327e−08 | 3.267575e−08 | −4.728467e−08 |
| C2 | 1.886015e−13 | −2.688758e−13 | 2.967232e−12 | −7.572255e−14 | 9.055008e−13 |
| C3 | −3.999614e−18 | 2.170901e−17 | −9.566852e−17 | 1.840367e−16 | 1.377885e−16 |
| C4 | 7.111600e−23 | −1.562284e−22 | 3.929337e−21 | −1.523276e−20 | −1.441510e−20 |
| C5 | −1.250529e−27 | 1.041316e−27 | −1.186605e−25 | 1.794391e−24 | 1.491915e−24 |
| C6 | 1.121438e−32 | 6.189194e−31 | 2.133202e−30 | −7.401338e−29 | −6.311102e−29 |

| | SRF | | |
|---|---|---|---|
| | 34 | 40 | 43 |
| K | 0 | 0 | 0 |
| C1 | 1.489916e−08 | −3.376562e−08 | −3.987147e−08 |
| C2 | −1.835927e−12 | 1.147859e−13 | 4.107807e−12 |
| C3 | 3.934589e−17 | 3.420639e−17 | −1.907925e−16 |
| C4 | 4.898015e−25 | −8.260741e−22 | 7.382131e−21 |
| C5 | −4.602523e−26 | −9.489841e−28 | −1.923670e−25 |
| C6 | 1.453074e−30 | 1.302094e−31 | 2.525917e−30 |

TABLE 4

| | | | | Refractive index | | |
|---|---|---|---|---|---|---|
| Surface | Radii | Thicknesses | Material | 157.285 nm | Diameter R | Diameter M |
| 1 | 0.000000 | 24.180697 | AIR | 1.00000000 | 63.920 | 69.327 |
| 2 | −131.473399 | 16.091224 | SIO2 | 1.56038550 | 65.950 | 70.490 |
| 3 | −119.940981 | 62.648089 | AIR | 1.00000000 | 70.217 | 74.526 |
| 4 | 378.858311 | 36.124259 | SIO2 | 1.56038550 | 92.305 | 94.677 |
| 5 | −378.858311 | 57.139166 | AIR | 1.00000000 | 92.945 | 95.037 |
| 6 | 1159.336540 | 15.000000 | SIO2 | 1.56038550 | 88.179 | 87.783 |
| 7 | −806.729452 | 1.029657 | AIR | 1.00000000 | 87.471 | 86.856 |
| 8 | 110.679187 | 47.403089 | SIO2 | 1.56038550 | 84.211 | 82.361 |
| 9 | 716.047782 | 22.082167 | AIR | 1.00000000 | 78.847 | 76.136 |
| 10 | −1098.190307 | 15.000000 | SIO2 | 1.56038550 | 69.045 | 65.731 |
| 11 | 1854.746910 | 78.586444 | AIR | 1.00000000 | 62.968 | 59.590 |
| 12 | −67.167659 | 15.000000 | SIO2 | 1.56038550 | 48.506 | 48.058 |
| 13 | −79.113926 | 80.104786 | AIR | 1.00000000 | 55.200 | 55.172 |
| 14 | −291.536263 | 33.733905 | SIO2 | 1.56038550 | 79.858 | 85.694 |
| 15 | −127.882878 | 30.833447 | AIR | 1.00000000 | 83.640 | 89.124 |
| 16 | 357.337981 | 25.737665 | SIO2 | 1.56038550 | 82.039 | 90.551 |
| 17 | −920.503134 | 99.000003 | AIR | 1.00000000 | 80.801 | 89.763 |
| 18 | 0.000000 | 0.000000 | AIR | 1.00000000 | 70.344 | 79.597 |
| 19 | 0.000000 | 49.000000 | AIR | 1.00000000 | 70.344 | 79.597 |
| 20 | 137.227552 | 38.207588 | SIO2 | 1.56038550 | 82.019 | 89.311 |
| 21 | 616.468862 | 243.028110 | AIR | 1.00000000 | 80.391 | 87.550 |
| 22 | −110.245756 | 15.000000 | SIO2 | 1.56038550 | 65.590 | 61.893 |
| 23 | −379.791190 | 31.448931 | AIR | 1.00000000 | 70.754 | 65.688 |
| 24 | −94.265286 | 16.469967 | SIO2 | 1.56038550 | 71.706 | 66.999 |
| 25 | −305.968417 | 26.192746 | AIR | 1.00000000 | 90.737 | 82.429 |
| 26 | −149.943122 | 0.000000 | REFL | 1.00000000 | 95.122 | 88.133 |
| 27 | 0.000000 | 26.192746 | REFL | 1.00000000 | 127.605 | 112.298 |
| 28 | 305.968417 | 16.469967 | SIO2 | 1.56038550 | 89.995 | 81.346 |
| 29 | 94.265286 | 31.448931 | AIR | 1.00000000 | 70.626 | 66.087 |
| 30 | 379.791190 | 15.000000 | SIO2 | 1.56038550 | 69.646 | 65.041 |
| 31 | 110.245756 | 243.028110 | AIR | 1.00000000 | 64.814 | 61.534 |
| 32 | −616.468862 | 38.207588 | SIO2 | 1.56038550 | 82.346 | 90.632 |
| 33 | −137.227552 | 48.999991 | AIR | 1.00000000 | 84.031 | 92.315 |
| 34 | 0.000000 | 0.000000 | AIR | 1.00000000 | 69.783 | 79.167 |
| 35 | 0.000000 | 88.360653 | AIR | 1.00000000 | 69.783 | 79.167 |
| 36 | 166.591952 | 27.990427 | SIO2 | 1.56038550 | 79.997 | 88.883 |
| 37 | 593.810795 | 224.587598 | AIR | 1.00000000 | 79.079 | 87.830 |
| 38 | −129.482114 | 15.000000 | SIO2 | 1.56038550 | 75.175 | 73.988 |
| 39 | 323.340670 | 36.193042 | AIR | 1.00000000 | 88.875 | 85.382 |
| 40 | 2325.102317 | 32.388201 | SIO2 | 1.56038550 | 106.429 | 100.844 |
| 41 | −372.543017 | 20.761061 | AIR | 1.00000000 | 112.866 | 106.892 |
| 42 | −24311.303947 | 59.127454 | SIO2 | 1.56038550 | 132.400 | 121.995 |
| 43 | −214.635740 | 13.107239 | AIR | 1.00000000 | 135.819 | 126.647 |
| 44 | 265.059033 | 43.056121 | SIO2 | 1.56038550 | 141.886 | 127.961 |
| 45 | −8610.028802 | 93.410128 | AIR | 1.00000000 | 140.011 | 125.153 |
| 46 | 0.000000 | 0.000000 | AIR | 1.00000000 | 127.180 | 108.716 |
| 47 | 0.000000 | −12.067203 | AIR | 1.00000000 | 127.180 | 108.716 |
| 48 | 448.770243 | 36.214411 | SIO2 | 1.56038550 | 127.014 | 108.703 |
| 49 | −1013.196545 | 1.000000 | AIR | 1.00000000 | 125.793 | 107.072 |
| 50 | 294.000043 | 32.641419 | SIO2 | 1.56038550 | 116.833 | 101.771 |
| 51 | 3798.096818 | 1.000000 | AIR | 1.00000000 | 113.515 | 97.558 |
| 52 | 148.871538 | 50.028540 | SIO2 | 1.56038550 | 95.519 | 86.092 |
| 53 | 622.296424 | 1.000000 | AIR | 1.00000000 | 81.737 | 71.891 |
| 54 | 57.698622 | 64.474917 | CAF2 | 1.51721724 | 52.647 | 50.748 |
| 55 | 0.000000 | 0.000000 | CAF2 | 1.51721724 | 12.905 | 14.425 |
| 56 | 0.000000 | 0.000000 | AIR | 0.00000000 | 12.905 | 14.425 |

TABLE 4A
Aspheric constants

| | SRF | | | | |
|---|---|---|---|---|---|
| | 2 | 7 | 12 | 17 | 20 |
| K | 0 | 0 | 0 | 0 | 0 |
| C1 | −2.098383e−09 | 4.733251e−08 | −5.559825e−08 | −3.242607e−09 | −2.892662e−08 |
| C2 | 1.901339e−12 | 1.091990e−12 | −4.793178e−12 | 3.383113e−13 | −8.205204e−13 |
| C3 | 1.492803e−16 | −1.018211e−17 | −7.260191e−16 | −1.249651e−17 | −3.548611e−17 |
| C4 | 2.612988e−20 | 8.439082e−22 | −5.004928e−19 | 8.885309e−22 | −2.980275e−21 |
| C5 | −1.754898e−24 | 8.705929e−26 | 1.299315e−22 | −6.466488e−26 | 1.566124e−25 |
| C6 | 2.957811e−28 | 3.034569e−30 | −4.716720e−26 | 2.195361e−30 | −1.506016e−29 |
| | SRF | | | | |
| | 22 | 31 | 33 | 37 | 38 |
| K | 0 | 0 | 0 | 0 | 0 |
| C1 | 5.677876e−08 | −5.677876e−08 | 2.892662e−08 | 1.123032e−08 | −6.157254e−08 |
| C2 | 2.662944e−12 | −2.662944e−12 | 8.205204e−13 | 1.359761e−13 | 1.868922e−12 |
| C3 | 1.909869e−16 | −1.909869e−16 | 3.548611e−17 | −1.880218e−17 | −1.031248e−16 |
| C4 | 2.831576e−20 | −2.831576e−20 | 2.980275e−21 | 1.171104e−21 | 7.072251e−21 |
| C5 | −2.692517e−24 | 2.692517e−24 | −1.566124e−25 | −5.775965e−26 | −1.449397e−24 |
| C6 | 6.928277e−28 | −6.928277e−28 | 1.506016e−29 | 1.358950e−30 | 1.174717e−28 |

| | SRF | | |
|---|---|---|---|
| | 40 | 45 | 53 |
| K | 0 | 0 | 0 |
| C1 | −4.313698e−09 | 2.724771e−08 | 1.845635e−08 |
| C2 | −1.362672e−12 | −1.323435e−13 | 1.338906e−12 |
| C3 | 3.928292e−17 | 1.889952e−19 | −1.105538e−16 |
| C4 | −1.859286e−21 | −2.634677e−23 | 1.141989e−20 |
| C5 | 6.264044e−26 | 1.324135e−27 | −6.528508e−25 |
| C6 | −2.415598e−30 | −9.911142e−33 | 2.177542e−29 |

1. A method, comprising:
illuminating a pattern arranged in an object plane of a projection objective with illumination radiation of an illumination system;
transirradiating the projection objective with radiation from the illuminated pattern to provide exposure radiation at an image plane of the projection objective;
setting a first exposure configuration of the projection objective, the first exposure configuration having a first image-side numerical aperture NA1 in a first image field at the image plane with a first image field size IFS1;
exposing at least one substrate to exposure radiation with the projection objective in the first exposure configuration;
setting a second exposure configuration of the projection objective by oppositely varying the image field size and image-side numerical aperture, the second exposure configuration having a second image-side numerical aperture NA2 and a second image field at the image plane with a second image field size IFS2, where NA2 is different from NA1 and IFS2 is different from IFS1; and
exposing at least one substrate to exposure radiation with the projection objective in the second exposure configuration.

2. The method of claim 1, wherein the projection objective has a higher image resolution for the first exposure configuration than the second exposure configuration.

3. The method of claim 2, wherein NA1>NA2 and IFS1<IFS2.

4. The method of claim 2, wherein substrates are exposed with higher throughput for when the projection objective is set with the second exposure configuration than with the first exposure configuration.

5. The method of claim 4, wherein NA1>NA2 and IFS1<IFS2.

6. The method of claim 1, wherein |NA1−NA2| is at least 0.05.

7. The method of claim 1, wherein IFS2 is at least 20% larger than IFS1.

8. The method of claim 1, wherein NA1≧1 and NA2≧1.

9. The method of claim 1, wherein oppositely varying the image field size and image-side numerical aperture to change the projection objective between the first and second exposure configurations occurs with the projection objective in the same location as exposing the substrates.

10. The method of claim 1, wherein the setting and exposing comprises:
exposing a first substrate by scanning the first substrate with exposure radiation from the projection objective in the first exposure configuration;
switching over the projection objective between the first and the second exposure configurations; and
exposing a second substrate by scanning the second substrate with exposure radiation from the projection objective in the second exposure configuration.

11. The method of claim 1, wherein setting the first or second exposure configurations comprises at least one manipulation on one or more optical elements of the projection objective, the at least one manipulation comprising a relative axial displacement of the optical elements, decentering one or more optical elements relative to the optical axis of the projection objective, or tilting an optical element about a tilt axis running transverse to the optical axis.

12. An apparatus, comprising:
a plurality of optical elements; and
an adjustable aperture stop;
wherein the apparatus is a projection objective configured so that during operation the projection objective images an object positioned in an object plane to an image plane by directing radiation from the object plane to the image plane,
the adjustable aperture stop being arranged a region of a pupil surface of the projection objective and configured to variably set an image-side numerical aperture of the projection objective,
the apparatus being adjustable between a first exposure configuration and at least one second exposure configuration differing from the first exposure configuration, where in the first exposure configuration the projection objective has a first image-side numerical aperture NA1 at a first image field with a first image field size IFS1, and in the second exposure configuration the projection objective has a second image-side numerical aperture NA2 at a second image field with a second image field size IFS2, where NA2 is different from NA1 and IFS2 is different from IFS1.

13. The apparatus of claim 12, wherein |NA1−NA2| is at least 0.05.

14. The apparatus of claim 12, wherein IFS2 is at least 20% larger than IFS1.

15. The apparatus of claim 12, further comprising an adjustable field stop configured to vary a size of the image field, wherein the adjustable field stop positioned in the region of the object plane or in the region of a field plane, the field plane being optically conjugate to the object plane of the projection objective.

16. The apparatus of claim 12, wherein the projection objective comprises at least one manipulator device configured to carrying out at least one manipulation of at least one of the optical elements, the at least one manipulation comprising a relative axial displacement of one or more of the optical elements, decentering one or more of the optical elements relative to the optical axis of the projection objective, or tilting one or more of the optical elements about a tilt axis running transverse to the optical axis.

17. The apparatus of claim 12, wherein for at least one of the exposure configurations, the projection objective has a slit-shaped image field with an aspect ratio AR between an image field width and an image field height, where AR>3.

18. The apparatus of claim 12, wherein the projection objective is a refractive projection objective.

19. The apparatus of claim 12, wherein the projection objective is a catadioptric projection objective.

20. The apparatus of claim 12, further comprising a radiation source configured so that during operation the radiation source provides the radiation to the projection objective.

21. The apparatus of claim 20, wherein the radiation has a wavelength of 193 nm or 248 nm.

22. The apparatus of claim 12, wherein a maximum dimension of IFS1 is 26 mm.

23. The apparatus of claim 22, wherein IFS1 is 26×6 mm².

24. The apparatus of claim 22, wherein IFS1>IFS2.

25. The apparatus of claim 24, wherein NA1<NA2.

26. The apparatus of claim 25, wherein NA1≧1.

27. A system, comprising:
the apparatus of claim 17,
wherein the system is a microlithography exposure system configured for use in scanning operation, the image field width being transverse to a scanning direction of the microlithography exposure system in scanning operation.

28. The system of claim 27, wherein the projection objective is designed for a scanning operation in both the first exposure configuration and the second exposure configuration.

29. The apparatus of claim 12, wherein the projection objective is an immersion projection objective configured to image a pattern arranged in the object plane into the image plane with the aid of an immersion medium.

30. The apparatus of claim 12, wherein NA1≧1 and NA2≧1.

31. A system, comprising:
an illumination system configured so that during operation the illumination system directs illumination radiation to an object plane;
a projection objective configured so that during operation the projection objective images a pattern arranged in the object plane to an image plane by directing radiation from the object plane to the image plane;
an adjustable aperture stop arranged in a region of a pupil surface of the projection objective, the adjustable aperture stop being configured to variably set an image-side numerical aperture of the projection objective;
an adjustable field stop arranged in a region of the object plane or in a region of a field plane, the field plane being optically conjugate to the object plane; and
a control device configured so that during operation the control device coordinates control of the adjustable field stop and of the adjustable aperture stop, the control device being configured to adjust the system between a first exposure configuration and a second exposure configuration,
wherein for the first exposure configuration the projection objective has a first image-side numerical aperture NA1 at a first image field at the image plane with a first image field size IFS1, and the second exposure configuration has a second image-side numerical aperture NA2 at a second image field at the image plane with a second image field size IFS2, where NA2 and NA1 are different, IFS2 and IFS1 are different, and the system is a microlithography exposure system.

32. The system of claim 31, wherein the microlithography exposure system is a scanning microlithography exposure system configured so that during operation the projection objective operates in a scanning mode in both the first exposure configuration and the second exposure configuration.

33. The apparatus of claim 31, wherein the projection objective is a refractive projection objective.

34. The apparatus of claim 31, wherein the projection objective is a catadioptric projection objective.

35. The system of claim 34, wherein the illumination radiation has a wavelength of 193 nm or 248 nm.

36. The apparatus of claim 31, wherein a maximum dimension of IFS1 is 26 mm.

37. The apparatus of claim 36, wherein IFS1 is 26×6 mm2.

38. The apparatus of claim 36, wherein IFS1>IFS2.

39. The apparatus of claim 38, wherein NA1<NA2.

40. The apparatus of claim 39, wherein NA1≧1.

41. A method, comprising:
carrying out an optical design process for determining the type and arrangement of optical elements in a projection objective, the projection objective being configured to image an object in an object plane to an image plane,
wherein the optical design process uses a plurality of parameters, the parameters comprising at least one fixed parameter and at least one free parameter, the optical design process comprising optimizing values for the at least one free parameter on the basis of a merit function, the merit function being selected such that in a first exposure configuration and in at least one second exposure configuration the projection objective has a correction state sufficient for microlithographic imaging in the image field, and
in the first exposure configuration the projection objective has first image-side numerical aperture NA1 at a first image field at the image plane with a first image field size IFS1, and in the second exposure configuration the projection objective has a second image-side numerical aperture NA2 at a second image field at the image plane with a second image field size IFS2, where NA2 and NA1 are different and IFS2 and IFS1 are different.

42. The method of claim 41, wherein the projection objective is designed for use in scanner operation, and for at least one exposure configuration the projection objective has a slit-shaped image field with an aspect ratio AR between the image field width transverse to a scanning direction and image field height in the scanning direction, where AR>3.

43. The method of claim 41, wherein the projection objective is designed for a scanning operation in both the first exposure configuration and the second exposure configuration.

44. The method of claim 41, wherein the projection objective is designed as an immersion projection objective configured to image a pattern arranged in the object plane into the image plane with the aid of an immersion medium

45. The method of claim 41, wherein NA1≧1 and NA2≧1.

46. The method of claim 41, wherein |NA1−NA2| is at least 0.05.

47. The method of claim 41, wherein IFS2 is at least 20% larger than IFS1.

48. A system, comprising:
an illumination system configured so that during operation the illumination system directs illumination radiation to an object plane;
a projection objective configured so that during operation the projection objective images a pattern arranged in the object plane to an image plane by directing radiation from the object plane to the image plane;
an adjustable aperture stop arranged in a region of a pupil surface of the projection objective, the adjustable aperture stop being configured to variably set an image-side numerical aperture of the projection objective;
an adjustable field stop arranged in a region of the object plane or in a region of a field plane, the field plane being optically conjugate to the object plane; and
a control device configured so that during operation the control device coordinates control of the adjustable field stop and of the adjustable aperture stop so that adjustments to the adjustable field stop are related to adjustments of the adjustable aperture stop.
